(19) United States
(12) Patent Application Publication
(10) Pub. No.: US 2014/0354407 A1
(43) Pub. Date: Dec. 4, 2014

(54) BEVERAGE COUNTING DEVICE

(71) Applicant: Paul Evans, Charlotte, NC (US)

(72) Inventor: Paul Evans, Charlotte, NC (US)

(21) Appl. No.: 13/909,486

(22) Filed: Jun. 4, 2013

(51) Int. Cl. G08B 5/22; G06M 1/24

(52) U.S. Cl. CPC G08B 5/22; G06M 1/24
USPC 340/6.1; 116/307; 116/201; 116/321; 116/309; 235/103

(57) ABSTRACT

A beverage counting device comprising a wrist band and one or more counters secured to the wrist band where the counters permit an individual the ability to record and display the number of beverages they have consumed. A method for using a beverage counting device comprising the steps of: providing a beverage counting device comprising a beverage counting device comprising a wrist band and one or more counters secured to the wrist band where the counters permit an individual the ability to record and display the number of beverages they have consumed; a) obtaining a beverage to drink; b) actuating a button on the counter to record the beverage; c) consuming the beverage; and d) repeating steps a) through c) until no further beverages are consumed.

### FIELD OF THE INVENTION

A portable device used to count and keep track of a number and a type of beverage consumed.

### BACKGROUND OF THE INVENTION

Alcohol poisoning is a serious and potentially deadly result of drinking large amounts of alcohol in a short period of time. Drinking too much too quickly can affect an individual's breathing, heart rate and gag reflex and potentially lead to coma and death. The main cause of alcohol poisoning is binge drinking which is defined as the rapid consumption of five or more drinks in a row. Alcohol poisoning can also occur when household products containing alcohol are accidentally or intentionally consumed. Alcohol poisoning symptoms include:

Confusion, stupor

Vomiting

Seizures

Slow breathing (less than eight breaths a minute)

Irregular breathing (a gap of more than 10 seconds between breaths)

Blue-tinged skin or pale skin

Low body temperature (hypothermia)

Unconsciousness (“passing out”), and can't be roused

A person with alcohol poisoning needs immediate medical attention due to the risks associated with it. Alcohol depresses the nerves that control involuntary actions such as breathing, heartbeat and gag reflex (prevents choking). Drinking too much alcohol can slow and, in some cases, shut down these functions. An individual's body temperature may also drop resulting in hypothermia or cardiac arrest. An individual's blood sugar level may fall low enough to cause seizures.

One way to prevent alcohol poisoning is to limit the number of alcoholic beverages consumed, or to increase the duration over which alcoholic beverages are consumed. Each of these goals may be achieved by the device disclosed within the instant patent application which permits an individual to count and keep track of the number and the type of beverage consumed.

### SUMMARY OF THE INVENTION

A beverage counting device comprising a wrist band and one or more counters secured to the wrist band where the counters permit an individual the ability to record and display the number of beverages they have consumed. A method for using a beverage counting device comprising the steps of: providing a beverage counting device comprising a beverage counting device comprising a wrist band and one or more counters secured to the wrist band where the counters permit an individual the ability to record and display the number of beverages they have consumed; a) obtaining a beverage to drink; b) actuating a button on the counter to record the beverage; c) consuming the beverage; and d) repeating steps a) through c) until no further beverages are consumed.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is an illustration of one embodiment of the present invention.

FIG. 2 is an illustration of one embodiment of the present invention.

FIG. 3 is an illustration of one embodiment of the present invention.

FIG. 4 is an illustration of one embodiment of the present invention.

FIG. 5 is an illustration of one embodiment of the present invention.

FIG. 6A is an illustration of one embodiment of the present invention.

FIG. 6B is an illustration of one embodiment of the present invention.

FIG. 6C is an illustration of one embodiment of the present invention.

FIG. 6D is an illustration of one embodiment of the present invention.

### DESCRIPTION OF THE INVENTION

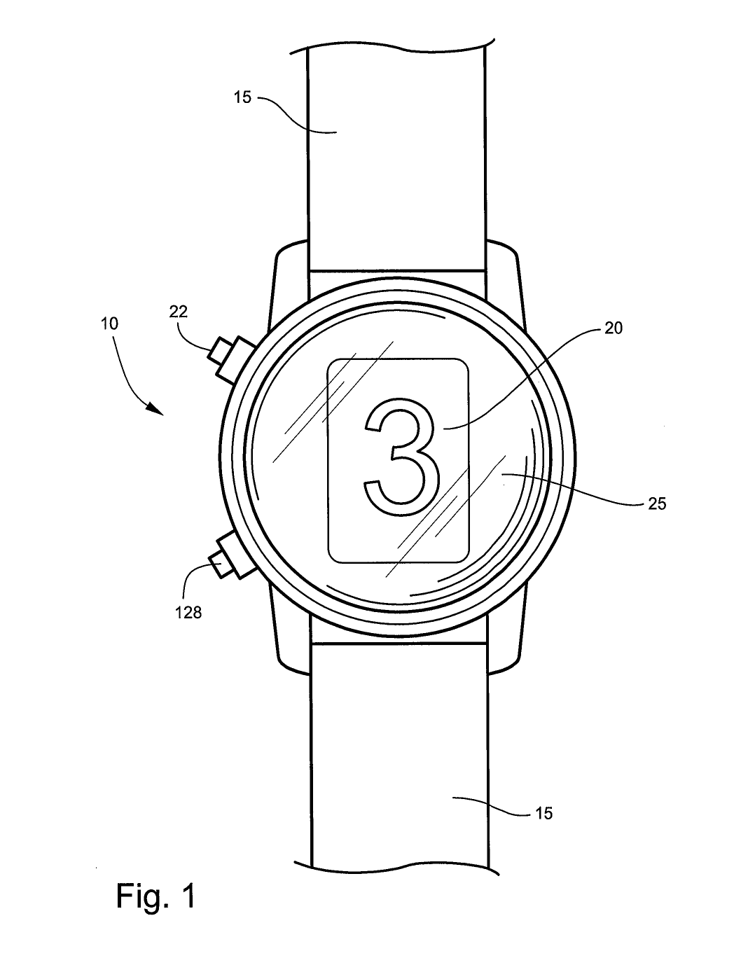

Looking to the figures, where like numerals refer to like elements, one can see in FIG. 1 that the instant invention describes a beverage counting device 10 which includes a wrist band 15 and one or more counters 20 secured to the wrist band 15, where the counter(s) permit an individual the ability to record and display the number of beverages they have consumed. The embodiment shown in FIG. 1 also illustrates a display 25 and a button 22 which may be actuated by an individual once for each additional beverage that the individual consumes. FIG. 1 also illustrates a reset button 28 which may be actuated by an individual after they have stopped consuming beverages or wish to keep track of the consumption of a different beverage.

A beverage counting device 10, as used herein, refers to a device which displays and stores the number of times a particular event has occurred. In the case of the instant invention, a beverage counting device 10 displays and stores the number of beverages that an individual has consumed. A beverage counting device 10 may include a wrist band 15 and one or more counters 20.

Wrist band 15, as used herein, refers to a band which encircles the entire wrist or a portion of a wrist. In the present invention, a wrist band 15 may be comprised of a material including, but not limited to, natural rubber, synthetic rubber, silicone, metal, leather, natural cloth, synthetic cloth, plastic, or a combination thereof.

Counter 20, as used herein, refers to a device which stores and displays the number of beverages the number of beverages an individual has consumed. A counter may be selected from the group including, but not limited to, a numeric/analog dial, a digital dial, an LED display, a digital display, a mechanical counter, a sliding counter, or a combination thereof. In one embodiment of the present invention, the counter 20 is non-electronic. In another embodiment, the counter 20 is electronic. In still another embodiment, the counter 20 is mechanical such as a tally counter which is known in the art. In the case of a counter 20 being an electronic counter, the counter 20 may include a circuit chip, a display 25 and a battery to power the circuit chip and display 25. In another embodiment, an electronic counter may be powered by a battery, a solar cell, or a combination thereof.

In one embodiment of the present invention, the beverage counting device is used to record the number of alcoholic beverages that an individual has consumed. In another embodiment of the present invention, the beverage counting device is used to record the number of both alcoholic beverages and non-alcoholic beverages (i.e. water, milk, soda, etc.) that an individual has consumed. In still another embodiment of the present invention, the beverage counting device further comprises one or more time components selected from the group including a timer, a stopwatch, a chronometer, or a combination thereof.

An alternative embodiment of the present invention describes a beverage counting device comprising a wrist band and a first counter secured to the wrist band which permits an individual the ability to record and display the number of alcoholic beverages they have consumed. The beverage counting device further includes a second counter secured to the wrist band which permits the individual the ability to record and display the number of non-alcoholic beverages they have consumed. The beverage counting device further includes one or more time components secured to the wrist band, the time component being selected from the group including a timer, a stopwatch, a chronometer, or a combination thereof. In one embodiment of the above invention the wrist band may be comprised of a material including, but not limited to, natural rubber, synthetic rubber, silicone, metal, leather, natural cloth, synthetic cloth, plastic, or a combination thereof. In another embodiment of the above invention, the counters may be selected from the group including, but not limited to, a numeric/analog dial, a digital dial, an LED display, a digital display, a mechanical counter, or a combination thereof. In another embodiment, the counter is non-electronic. In yet another embodiment, the counter is electronic. In still another embodiment, the counter 20 is mechanical such as a tally counter which is known in the art. In the case of a counter being an electronic counter, the counter may include a circuit chip, a display and a battery to power the circuit chip and display. In another embodiment, an electronic counter may be powered by a battery, a solar cell, or a combination thereof.

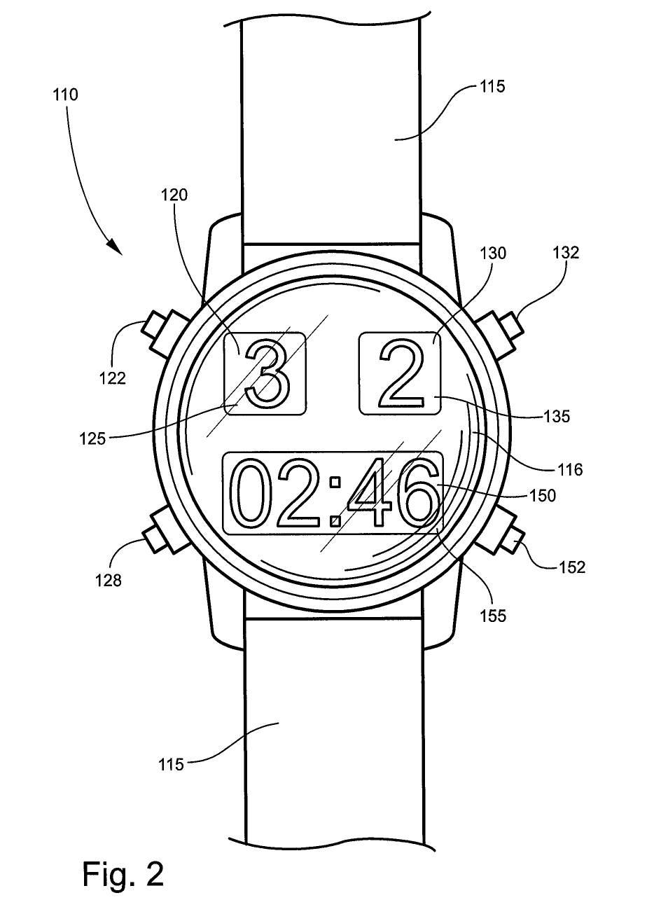

Looking again to the figures, we see that FIG. 2 illustrates a beverage counting device 110 comprising a wrist band 115 made of any material previously mentioned and a display 116. The display 116 includes a first counter 120 with a display 125, a second counter 130 with a display and a time component 150 with a display 155. The number displayed on the first counter 120 is increased when an individual actuates the button 122 located on the side of the device. The number displayed on the second counter 130 is increased when an individual actuates the button 132 located on the side of the device. The time component 150 may be activated and/or deactivated when an individual actuates the button 152 located on the side of the device. When desired, each of the displays may be reset or zeroed out by an individual actuating the reset button 128 located on the side of the device. The time component 150 of the embodiment illustrated in FIG. 2 may be selected from the group including a timer, a stopwatch, a chronometer, or a combination thereof.

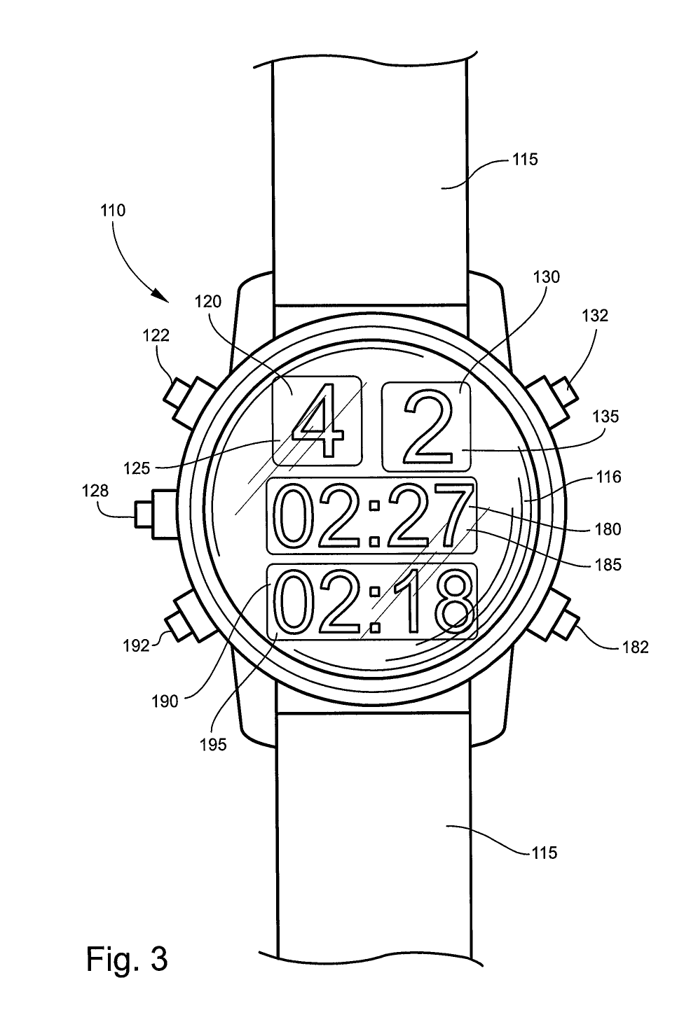

Looking now to FIG. 3 there is illustrated a beverage counting device 110 comprising a wrist band 115 made of any material previously mentioned and a display 116. The display 116 includes a first counter 120 with a display 125, a second counter 130 with a display, a first time component 180 with a display 185 and a second time component 190 with a display 195. The number displayed on the first counter 120 is increased when an individual actuates the button 122 located on the side of the device. The number displayed on the second counter 130 is increased when an individual actuates the button 132 located on the side of the device. The first time component 180 may be activated and/or deactivated when an individual actuates the button 182 located on the side of the device. The second time component 190 may be activated and/or deactivated when an individual actuates the button 192 located on the side of the device. When desired, each of the displays may be reset or zeroed out by an individual actuating the reset button 128 located on the side of the device. The time components 180 and 190 of the embodiment illustrated in FIG. 3 may be selected from the group including a timer, a stopwatch, a chronometer, or a combination thereof.

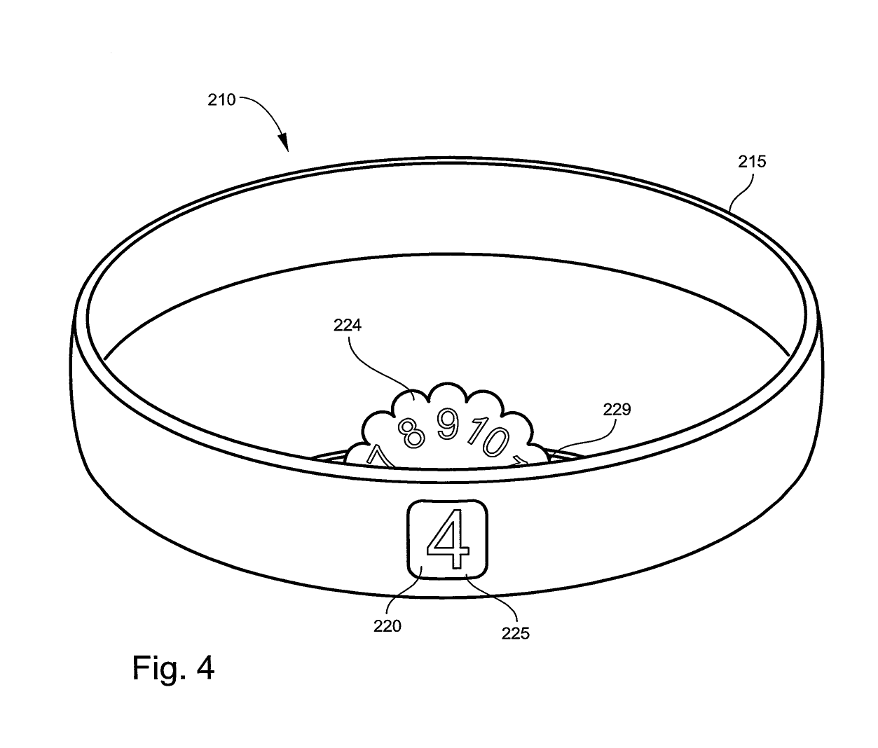

Looking now to FIG. 4 there is illustrated another embodiment of the present invention. FIG. 4 includes a beverage counting device 210 comprising a wrist band 215 made of any material previously mentioned and a counter 220 having a display 225. The embodiment illustrated in FIG. 4 is a non-electronic counter with numbers used to display the number of drinks consumed being located on a rotatable dial 224. In the embodiment, the dial 224 is located within the body of the wrist band 215 in what may be described as a pocket 229. The dial 224 may be mounted within the pocket 229 by any means known in the art which permit the dial to be rotatable and display a number within the display 225. The dial 224 may be rotatably mounted on a mounting post, an axel, a pin or any similar device. The dial 224 may operate and maintain its desired position (i.e. indicating a number “2” if an individual has consumed two drinks) through friction with the inside of the pocket 229, through the use of detents located on the outer surface of the dial 224, or by any other means known in the art.

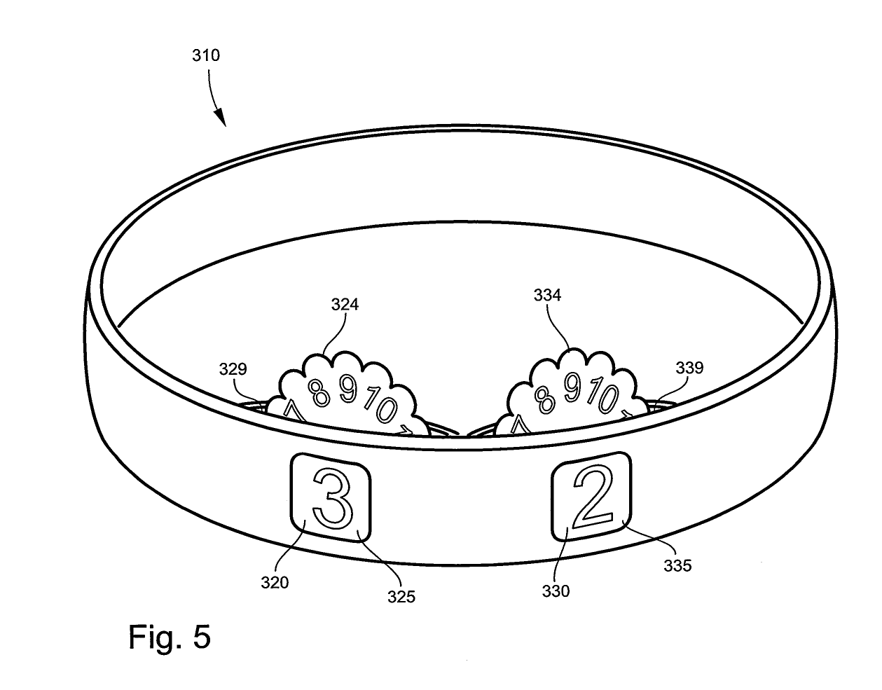

Looking now to FIG. 5 there is illustrated another embodiment of the present invention. FIG. 5 includes a beverage counting device 310 comprising a wrist band 315 made of any material previously mentioned, a first counter 320 having a display 325 and a second counter 330 having a display 335. The embodiment illustrated in FIG. 5 is a non-electronic counter with numbers used to display the number of drinks consumed being located on a pair of rotatable dials 324 and 334. In the embodiment, each dial 324 and 334 is located within the body of the wrist band 315 in what may be described as a pocket 329 for the first dial 324 and a pocket 339 for the second dial. In one embodiment, two or more dials may be located within the same pocket embedded in the wrist band 315. The dial 224 may be mounted within the pocket 230 by any means known in the art which permit the dial to be rotatable and display a number within the display 225. The dial 224 may be rotatably mounted on a mounting post, an axel, a pin or any similar device. The dial 224 may operate and maintain it's desired position (i.e. indicating a number “2” if an individual has consumed two drinks) through friction with the inside of the pocket 230, through the use of detents located on the outer surface of the dial 224, or by any other means known in the art.

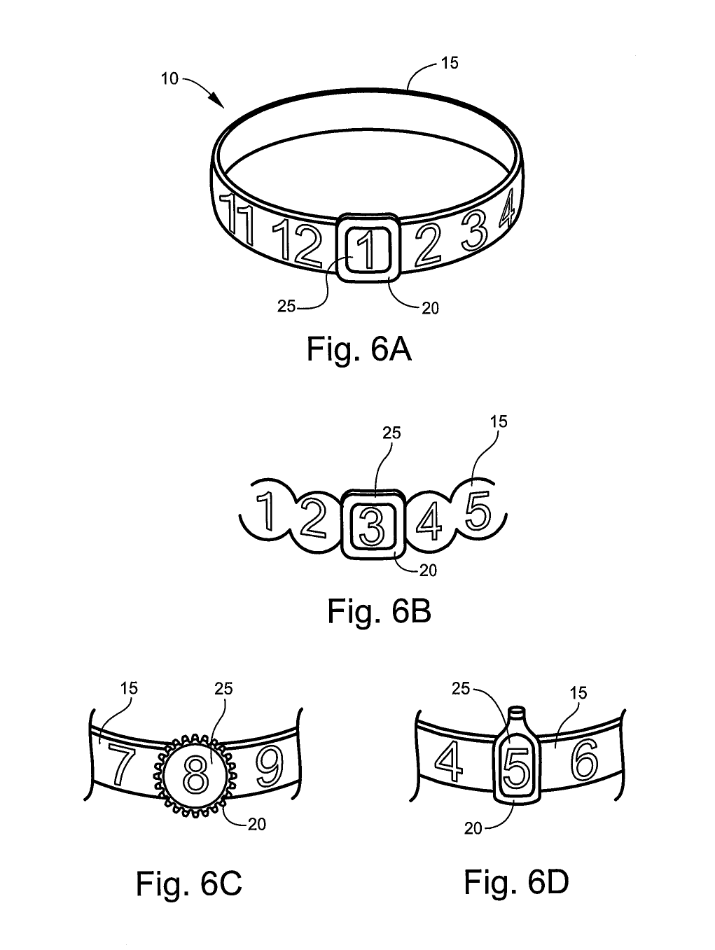

Looking now to FIGS. 6a through 6d, there is illustrated another embodiment of the present invention. FIGS. 6a through 6d each illustrate a beverage counting device 10 including a wrist band 15, a counter 20 and a display 25. In these embodiments, numbers are shown on the wrist band 15 which are displayed on the outer surface of the wrist band 15. The counter 15 as illustrated is slidably engaged to the bracelet and may be moved by an individual thereby giving that individual the ability to record and display the number of alcoholic beverages or non-alcoholic beverages they have consumed. In another embodiment of the present invention, the counter illustrated in FIGS. 6a through 6d may include both a first counter 20 and first display 25 and a second counter and a second display (not illustrated) This would permit an individual the ability to record and display the number of alcoholic beverages they have consumed on the first counter and first display and permit the same individual the ability to record and display the number of non-alcoholic beverages they have consumed on the second counter and the second display. In one embodiment of the present invention, the counter may be the same color as the wrist band. In another embodiment of the present invention, the counter may be a different color than the wrist band. In still another embodiment, the counter may be made to resemble other known shapes including, but not limited to, a bottle cap, a liquor bottle, a wine bottle, a shot glass, a ring, or a combination thereof.

The present invention further includes a method for using a beverage counting device comprising the steps of: providing a beverage counting device comprising a wrist band and one or more counters secured to the wrist band where the counters permit an individual the ability to record and display the number of beverages they have consumed by then:

a) obtaining a beverage to drink;

b) actuating a button on the counter or rotating a dial on the counter to record the beverage;

c) consuming the beverage; and

d) repeating steps a) through c) until no further beverages are consumed.

In one embodiment of the above method, the wrist band may be comprised of a material including, but not limited to, natural rubber, synthetic rubber, silicone, metal, leather, natural cloth, synthetic cloth, plastic, or a combination thereof. In another embodiment of the above method, the counters may be selected from the group including, but not limited to, a numeric/analog dial, a digital dial, an LED display, a digital display, a mechanical counter, or a combination thereof. In another embodiment of the above method, the beverage counting device is used to record the number of alcoholic beverages that an individual has consumed. In yet another embodiment of the above method, the beverage counting device is used to record the number of both alcoholic beverages and non-alcoholic beverages that an individual has consumed. In still another embodiment of the above method, the beverage counting device further comprises one or more time components selected from the group including a timer, a stopwatch, a chronometer, or a combination thereof.

An alternative embodiment of the present invention describes a beverage counting device comprising a wrist band and a first counter secured to the wrist band which permits an individual the ability to record and display the number of alcoholic beverages they have consumed. The beverage counting device further includes a second counter secured to the wrist band which permits the individual the ability to record and display the number of non-alcoholic beverages they have consumed. The beverage counting device further includes one or more time components secured to the wrist band, the time component being selected from the group including a timer, a stopwatch, a chronometer, or a combination thereof. In one embodiment of the above invention the wrist band may be comprised of a material including, but not limited to, natural rubber, synthetic rubber, silicone, metal, leather, natural cloth, synthetic cloth, plastic, or a combination thereof. In another embodiment of the above invention, the counters may be selected from the group including, but not limited to, a numeric/analog dial, a digital dial, an LED display, a digital display, a mechanical counter, or a combination thereof. In another embodiment, the counter is non-electronic. In yet another embodiment, the counter is electronic. In still another embodiment, the counter 20 is mechanical such as a tally counter which is known in the art. In the case of a counter being an electronic counter, the counter may include a circuit chip, a display and a battery to power the circuit chip and display. In another embodiment, an electronic counter may be powered by a battery, a solar cell, or a combination thereof.

The present invention further includes a method for using a beverage counting device comprising the steps of: providing a beverage counting device comprising a wrist band and two counters secured to the wrist band where the counters permit an individual the ability to record and display the number of both alcoholic beverages and non-alcoholic beverages that an individual has consumed by then;

a) obtaining a beverage to drink;

b) actuating a button on a first counter to record an alcoholic beverage or actuating a button on a second counter to record a non-alcoholic beverage;

c) consuming the beverage; and

d) repeating steps a) through c) until no further beverages are consumed.

In one embodiment of any of the above methods, the one or more counters may be electronic counters and the electronic counters are powered by a battery, a solar cell, or a combination thereof. In another embodiment, the above method may further comprise one or more time components selected from the group including a timer, a stopwatch, a chronometer, or a combination thereof and further adding the steps of:
activating the time component prior to consuming a first beverage; and
deactivating the time component when beverage consumption has ceased.

The present invention further includes another method for using a beverage counting device comprising the steps of: providing a beverage counting device comprising a wrist band and one or more counters secured to the wrist band where the counters permit an individual the ability to record and display the number of either alcoholic beverages or non-alcoholic beverages that an individual has consumed by then;

a) obtaining a beverage to drink;

b) rotating a dial on a first counter to record the beverage;

c) consuming the beverage; and

d) repeating steps a) through c) until no further beverages are consumed.

In one embodiment of any of the above methods, the beverages may be alcoholic beverages, non-alcoholic beverages, or a combination thereof. In another embodiment, the above method may further comprise one or more time components selected from the group including a timer, a stopwatch, a chronometer, or a combination thereof and further adding the steps of:
activating the time component prior to consuming a first beverage; and
deactivating the time component when beverage consumption has ceased.

The present invention further includes a method for using a beverage counting device comprising the steps of: providing a beverage counting device comprising a wrist band and two counters secured to the wrist band where the counters permit an individual the ability to record and display the number of both alcoholic beverages and non-alcoholic beverages that an individual has consumed by then;

a) obtaining a beverage to drink;

b) rotating a dial on a first counter to record an alcoholic beverage or rotating a dial on a second counter to record a non-alcoholic beverage;

c) consuming the beverage; and

d) repeating steps a) through c) until no further beverages are consumed.

In another embodiment, the above method may further comprise one or more time components selected from the group including a timer, a stopwatch, a chronometer, or a combination thereof and further adding the steps of:
activating the time component prior to consuming a first beverage; and
deactivating the time component when beverage consumption has ceased.

The present invention further includes another method for using a beverage counting device comprising the steps of: providing a beverage counting device comprising a wrist band and one or more counters secured to the wrist band where the counters permit an individual the ability to record and display the number of either alcoholic beverages or non-alcoholic beverages that an individual has consumed by then;

a) obtaining a beverage to drink;

b) sliding or moving a counter on the wrist band to record the beverage;

c) consuming the beverage; and

d) repeating steps a) through c) until no further beverages are consumed.

In one embodiment of any of the above methods, the beverages may be alcoholic beverages, non-alcoholic beverages, or a combination thereof. In another embodiment, the above method may further comprise one or more time components selected from the group including a timer, a stopwatch, a chronometer, or a combination thereof and further adding the steps of:
activating the time component prior to consuming a first beverage; and
deactivating the time component when beverage consumption has ceased.

Any of the above device embodiments described above may be incorporated into and/or adapted to be utilized in the methods described above. While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

The present invention may be embodied in other forms without departing from the spirit and the essential attributes thereof, and, accordingly, reference should be made to the appended claims, rather than to the foregoing specification, as indicating the scope of the invention. Additionally, the invention illustratively disclosed herein suitably may be practiced in the absence of any element which is not specifically disclosed herein.

I claim:

1. A beverage counting device comprising:
a wrist band;
one or more counters secured to said wrist band;
said counters permitting an individual the ability to record and display the number of beverages they have consumed.

2. The device of claim 1 wherein said wrist band being comprised of a material including, but not limited to, natural rubber, synthetic rubber, silicone, metal, leather, natural cloth, synthetic cloth, plastic, or a combination thereof.

3. The device of claim 1 wherein said counters being selected from the group including, but not limited to, a numeric/analog dial, a digital dial, an LED display, a digital display, a mechanical counter, a sliding counter, or a combination thereof.

4. The device of claim 1 wherein said device is used to record the number of alcoholic beverages that an individual has consumed.

5. The device of claim 1 wherein said device is used to record the number of both alcoholic beverages and non-alcoholic beverages that an individual has consumed.

6. The device of claim 1 wherein said one or more counters being electronic counters and said electronic counters being powered by a battery, a solar cell, or a combination thereof.

7. The device of claim 1 further comprising one or more time components selected from the group including a timer, a stopwatch, a chronometer, or a combination thereof.

8. A beverage counting device comprising:
a wrist band;
a first counter secured to said wrist band;
said first counter permitting an individual the ability to record and display the number of alcoholic beverages they have consumed;
a second counter secured to said wrist band;
said second counter permitting an individual the ability to record and display the number of non-alcoholic beverages they have consumed; and
one or more time components secured to said wrist band, said time component being selected from the group including a timer, a stopwatch, a chronometer, or a combination thereof.

9. The device of claim 8 wherein said wrist band being comprised of a material including, but not limited to, natural rubber, synthetic rubber, silicone, metal, leather, natural cloth, synthetic cloth, plastic, or a combination thereof.

10. The device of claim 8 wherein said counters being selected from the group including, but not limited to, a numeric/analog dial, a digital dial, an LED display, a digital display, a mechanical counter, a sliding counter, or a combination thereof.

11. The device of claim 8 wherein said one or more counters being electronic counters and said electronic counters being powered by a battery, a solar cell, or a combination thereof.

12. A method for using a beverage counting device comprising the steps of:
providing a beverage counting device comprising:
a wrist band;
one or more counters secured to said wrist band;
said counters permitting an individual the ability to record and display the number of beverages they have consumed;
a) obtaining a beverage to drink;
b) actuating a button on said counter or rotating a dial on said counter to record said beverage;
c) consuming said beverage; and
d) repeating steps a) through c) until no further beverages are consumed.

13. The method of claim 12 wherein said wrist band being comprised of a material including, but not limited to, natural rubber, synthetic rubber, silicone, metal, leather, natural cloth, synthetic cloth, plastic, or a combination thereof.

14. The method of claim 12 wherein said counters being selected from the group including, but not limited to, a numeric/analog dial, a digital dial, an LED display, a digital display, a mechanical counter, or a combination thereof.

15. The method of claim 12 wherein said device is used to record the number of alcoholic beverages that an individual has consumed.

16. The method of claim 12 wherein said device is used to record the number of both alcoholic beverages and non-alcoholic beverages that an individual has consumed through the steps of;
a) obtaining a beverage to drink;
b) actuating a button on a first counter to record an alcoholic beverage or actuating a button on a second counter to record a non-alcoholic beverage;
c) consuming said beverage; and
d) repeating steps a) through c) until no further beverages are consumed.

17. The method of claim 12 wherein said one or more counters being electronic counters and said electronic counters being powered by a battery, a solar cell, or a combination thereof.

18. The method of claim 12 further comprising one or more time components selected from the group including a timer, a stopwatch, a chronometer, or a combination thereof and further adding the steps of:
activating said time component prior to consuming a first beverage; and
deactivating said time component when beverage consumption has ceased.
